(19) United States
(12) Patent Application Publication
(10) Pub. No.: US 2018/0286441 A1
(43) Pub. Date: Oct. 4, 2018

(54) HEAT ASSISTED MAGNETIC RECORDING (HAMR) MEDIA WITH EXCHANGE TUNING LAYER

(71) Applicant: Seagate Technology LLC, Cupertino, CA (US)

(72) Inventor: Bin LU, San Ramon, CA (US)

(21) Appl. No.: 15/472,089

(22) Filed: Mar. 28, 2017

(51) Int. Cl. G11B 5/65; G11B 5/82

(52) U.S. Cl. CPC G11B 5/653; G11B 2005/0021; G11B 5/82; G11B 5/656

(57) ABSTRACT

An apparatus is disclosed. The apparatus includes a storage layer, an exchange tuning layer, and a write layer. The storage layer is magnetic. The exchange tuning layer is disposed over the storage layer. The exchange tuning layer is weakly magnetic. The write layer is disposed over the exchange tuning layer. The write layer is magnetic and the exchange tuning layer magnetically weakens magnetic coupling between the storage layer and the write layer.

### BACKGROUND

Certain devices use disk drives with heat assisted magnetic recording (HAMR) media to store information. For example, disk drives can be found in many desktop computers, laptop computers, and data centers. HAMR media store information magnetically as bits. In HAMR writing process, a fine laser spot may heat up the HAMR media above its Curie temperature in order to switch its magnetization orientation. Superparamagnetic trap may result which causes a grain within the HAMR media to have a wrong magnetization orientation once it is cooled. Superparamagnetic trap therefore impacts performance and reliability of the HAMR media.

### SUMMARY

Provided herein is an apparatus that is capable of reducing superparamagnetic traps and capable of maintaining epitaxial growth in a HAMR media. The apparatus includes a storage layer, an exchange tuning layer, and a write layer. The storage layer is magnetic. The exchange tuning layer is disposed over the storage layer. The exchange tuning layer is weakly magnetic at the elevated writing temperature. The write layer is disposed over the exchange tuning layer. The write layer is magnetic and the exchange tuning layer magnetically weakens magnetic coupling between the storage layer and the write layer. These and other features and advantages will be apparent from a reading of the following detailed description.

### BRIEF DESCRIPTION OF DRAWINGS

FIG. 1 shows a heat assisted magnetic recording (HAMR) media according to one aspect of the present embodiments.

FIGS. 2A-2E show the HAMR media that undergoes a write process according to one aspect of the present embodiments.

FIG. 3 shows another HAMR media according to one aspect of the present embodiments.

FIG. 4 shows yet another HAMR media according to one aspect of the present embodiments.

FIG. 5 shows yet another HAMR media variation according to one aspect of the present embodiments.

FIGS. 6A-6E show the HAMR media of FIG. 5 that undergoes a write process according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “middle,” “bottom,” “beside,” “forward,” “reverse,” “overlying,” “underlying,” “up,” “down,” or other similar terms such as “upper,” “lower,” “above,” “below,” “under,” “between,” “over,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It is understood HAMR media may include both granular magnetic layers and continuous magnetic layers. Granular layers include grains that are segregated in order to physically and magnetically decouple the grains from one another. Segregation of the grains may be done, for example, with formation of segregants such as oxides, carbon (C), boron (B), boron nitride (BN), etc., at the boundaries between adjacent magnetic grains. As such, the segregated magnetic grains form a granular layer. When multiple granular layers stacked together they form a columnar structure, where the magnetic alloys are hetero-epitaxially grown into columns while the oxides segregate into grain (column) boundaries. HAMR media may include both granular layers and continuous layers. In some embodiments, the exchange tuning layer may also improve the epitaxial growth within the HAMR media.

As the technology of heat assisted magnetic recording (HAMR) media reaches maturity, it becomes increasingly difficult to continue to increase the storage capacity of recording media (e.g. disk drive disks) or to reduce the size of recording media while maintaining storage capacity. Such challenges may be overcome by increasing the bit density on the recording media. Unfortunately, increasing the bit density that may require segregants in order to separate the grains from one another may disrupt the epitaxial growth of the HAMR media. The epitaxial growth of the magnetic layers is challenged when segregant materials are introduced. As a result, increasing the thickness of the total magnetic layer may cause random orientation in the top layer of the HAMR media.

Furthermore, in HAMR media performance may suffer from superparamagnetic traps. For example, during recording, a fine laser spot heats the magnetic grains above the Curie temperature. As the disk rotates away from the laser spot, the heated region quickly cools down at the presence of a magnetic field. As the magnetic grains cools down, their magnetization (Mₛ) and anisotropy filed (Hₖ) increase dramatically. The magnetization orientation of the uniaxial perpendicular magnetic grains can be switched by the magnetic writing field (H_{write}) from the transducer as long as H_{write}>Hₖ. As the grains cool down further, the Hₖ increase more, to a point where H_{write}<=Hₖ the magnetization is no longer switchable by the H_{write}. The magnetization orientation is frozen in the same direction as that of the H_{write}. The temperature where the H_{write}=Hₖ is called T_{write}. The temperature T_{write} is the temperature that the magnetization orientations is set. Thermal perturbation is a factor to be considered during the magnetization frozen process. At an elevated temperature the thermal fluctuation energy kT_{write}, where k is the Boltzmann constant could be very comparable to the Zeeman energy, E_{Zeeman}=0.5 H_{write}.MₛV, where V is the volume of a magnetic grain. As a result, the magnetization could be frozen into an undesired direction with very high probability. Such a phenomena is called superparamagnetic traps.

Accordingly, enhancing H_{write}, Mₛ, or V are alternatives to increase the E_{Zeeman}/kT_{write} ratio in order to reduce the superparamagnetic trap effect. From media design stand point, H_{write} is fixed once a transducer is fabricated and shipped to a HAMR drive. Magnetization (Mₛ) of the media can be increased as long as there are no other negative impacts on the magnetic recording. The volume of the magnetic grain can be expressed as V=Dt, where D is average grain size and t magnetic layer total thickness. Increasing grain size may adversely impact storage areal density. Therefore, it is may be desirable to have a larger thickness (t). Unfortunately, as mentioned above, due to large amount of segregant volume percentage (vol %), the magnetic layer cannot be grown very thick because increasing the thickness results in the media losing its self-epitaxy. The embodiments presented herein mitigate the superparamagnetic trap effect.

According to some embodiments, the exchange tuning layer may be disposed between the storage layer and the write layer (also referred to as hard layer and soft layer). The exchange tuning layer may be nonmagnetic or weakly magnetic at the elevated temperature (e.g. T_{write}). In some embodiments, the exchange tuning layer may include a material that is magnetic with higher Curie temperature than the storage layer but the exchange tuning layer may still be weakly magnetic or nonmagnetic at T_{write}. The exchange tuning layer weakens the magnetic coupling between the storage layer and the write layer. It is appreciated that the exchange strength can be tuned by the magnetization (Mₛ) and the thickness of the exchange tuning layer. Thus, the magnetization orientation of the write layer may be switched during the write process first before the magnetization orientation of the storage layer is switched. The switching of the magnetization orientation of the write layer has an additive effect with the external field that is being applied (e.g., is in the same orientation as the external field) for writing into the storage layer, thus lowering a required external field to write to the storage layer, effectively increasing the transducer magnetic field. As a result, the T_{write} may be reduced. Moreover, the Zeeman energy of the magnetic switching is now calculated as E_{Zeeman}=0.5H_{write} (Mₛ₁V₁+Mₛ₂V₂), where Mₛ₁ and V₁ stands for saturation magnetization and grain average volume of the storage layer, respectively, and Mₛ₂ and V₂ stands for saturation magnetization and grain average volume of the write layer, respectively. Thus the addition of the exchange tuning layer and the write layer to the storage layer enhances the Zeeman energy to kT_{write} ratio. Hence superparamagnetic trap effect is reduced. Furthermore, a selection of the exchange tuning layer may promote epitaxial growth of the HAMR media. For example, the exchange tuning layer may include nonmagnetic or weakly magnetic material with face centered cubic (fcc) crystal structure or L1₀ crystal structure that further aids the growth of the top write layer. The exchange tuning layer may or may not contain segregants in some embodiments.

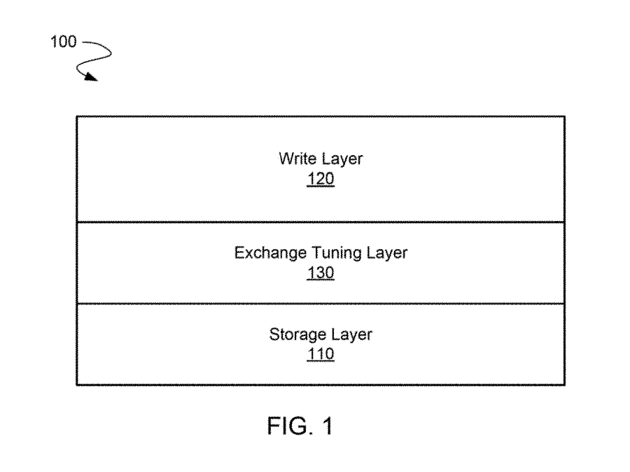

FIG. 1 shows a HAMR media 100 according to one aspect of the present embodiments. The HAMR media 100 may include a storage layer 110, an exchange tuning layer 130 disposed over the storage layer 110, and a write layer 120 disposed over the exchange tuning layer 130. In other words, the exchange tuning layer 130 is disposed between the storage layer 110 and the write layer 120. It is appreciated that the storage layer 110 may be one layer or multiple layers. Similarly, the write layer 120 may be one layer or multiple layers. It is appreciated that the exchange tuning layer 130 may similarly be one layer or multiple layers. In some embodiments, the exchange tuning layer 130 may a non-magnetic layer or a weak magnetic layer that magnetically decouples the storage layer 110 from the write layer 120. In some embodiments, the exchange tuning layer 130 weakens the magnetic coupling between the storage layer 110 and the write layer 120.

According to some embodiments, the write layer 120 may include material such as FePt, FePtMo, FePtCo, FePtNi, FeCoPt, CoPt, CoNiFe, CoFe, CoCrPt, CoCrPtRu, or alloy thereof. The crystalline structure of the write layer could be of a cubic structure, such as bcc, fcc, or L1₀ etc. In other embodiments, the write layer 120 may include material such as CoFe, CoNi, CoCr, or alloy thereof, FeCoCrNiPt or alloy thereof, CoCrPt or alloy thereof, etc., of cubic structure such as fcc structure, bcc, derivative of bcc structure known as B2, etc. It is appreciated that the write layer 120 and the storage layer 110 may have a substantially similar or the same Curie temperature, e.g., the Curie temperature of the write layer 120 may be within 30% of the Curie temperature of the storage layer 110. In some embodiments, the write layer 120 has a higher room temperature saturation magnetization than the storage layer 110. Furthermore, the room temperature anisotropy field Hₖ for the write layer 120 is lower than the anisotropy field of the storage layer 110, in some embodiments. At room temperature, Hₖ of the write layer may be approximately at 0-5 kOe. The thickness of the write layer 120 may range between 0.2-3 nm. In some embodiments, the thickness may range between 0.2-5 nm.

It is appreciated that the write layer 120 may be a continuous layer or one or more granular layers. For example, the write layer 120 may include grain decoupling material, e.g., B, C, carbide such as SiC, BC, TiC, TaC, etc., nitride such as BN, SiN, TiN, etc., oxide such as SiO₂, B₂O₃, WO₃, Ta₂O₅, TiO₂, etc., or any combination thereof.

According to some embodiments, the storage layer 110 may include magnetic material of L1₀ structure, e.g., FePt, FePtCu, FePtAg, FePtCuAg, FePtMo, FePtCo, FePtNi, CoPt, FeCoPt, and CoPdPt or alloy thereof. It is appreciated that the write layer 120 and the storage layer 110 may have a substantially similar or the same Curie temperature, e.g., the Curie temperature of storage layer 110 may be within 30% of the Curie temperature of the write layer 110. In some embodiments, the storage layer 110 has a lower room temperature saturation magnetization than the write layer 120. Furthermore, the anisotropy field for the storage layer 110 is higher than the anisotropy field for the write layer 120, in some embodiments. The thickness of the storage layer 110 may range between 1-10 nm. In some embodiments, the thickness may range between 1-5 nm. The thickness of the storage layer 110 may range between 2-15 nm.

It is appreciated that the storage layer 110 may be a continuous layer or one or more granular layers. For example, the storage layer 110 may include grain decoupling material, e.g., B, C, carbide such as SiC, BC, TiC, TaC, etc., nitride such as BN, SiN, TiN, etc., oxide such as SiO₂, B₂O₃, WO₃, Ta₂O₅, TiO₂, etc., or any combination thereof.

In some embodiments, the exchange tuning layer 130 may include material such as PtX where X is a magnetic material with high Curie temperature but where PtX is nonmagnetic or weakly magnetic. In some embodiments X may be Co that has a high Curie temperature. X may also include material such as Cu, Ru, Ni, Rh, Nd, Ag, etc., or any combination thereof. It is appreciated that the alloy of PtX may be selected for the exchange tuning layer 130 such that the magnetic coupling between the storage layer 110 and the write layer 120 is weakened and tunable by varying its thickness. In some embodiments, the exchange tuning layer 130 may include MgO. In some embodiments, the exchange tuning layer 130 may include CuAu, or an alloy of transition metals with cubic structure. The crystalline structure of the materials used for exchange tuning layer 130 could be cubic, such as, bcc, fcc, bcc-derivative, fcc-derivative, L1₀, etc.

It is appreciated that the exchange tuning layer 130 may be a continuous layer or one or more granular layers. For example, the exchange tuning layer 130 may include grain decoupling material, e.g., B, C, carbide such as SiC, BC, TiC, TaC, etc., nitride such as BN, SiN, TiN, etc., oxide such as SiO₂, B₂O₃, WO₃, Ta₂O₅, TiO₂, etc., or any combination thereof. According to some embodiments, the exchange tuning layer 130 maintains the granular structures, magnetization orientation and anisotropy between the storage layer 110 to the write layer 120. The alloy of CuAg, PtX or MgO may be used to promote epitaxial growth between the storage layer 110 and the write layer 120. For example, the exchange tuning layer 130 may be a face centered cubic crystalline structure, thus enabling epitaxial growth between the storage layer 110 and the write layer 120 in (001) orientation. In some embodiments, the storage layer 110 and the write layer 120 may have a crystalline growth structure in (002) orientation of L1₀ structure and the exchange tuning layer 130 may have a crystalline structure growth in (200) orientation of a cubic structure. The exchange tuning layer 130 may be a thin layer, e.g., 20 Å or less. In some embodiments, the exchange tuning layer 130 may be between 0-5 nm in thickness.

It is appreciated that the write layer 120 may have a lower anisotropy field than the storage layer 110. Furthermore, the write layer 120 may have a higher or the same room temperature saturation magnetization as the storage layer 110. However, the write layer 120 has a higher or the same Curie temperature as the storage layer 110. Accordingly, the exchange tuning layer 130 may be selected such that it exchange tunes the storage layer 110 by weakening the magnetic coupling between the storage layer 110 and the write layer 120 such that the write layer 120 is magnetically switched first prior to the storage layer 110 switching when the HAMR media is being written to (i.e. in presence of external magnetization field and during the heating process). During the HAMR write process, e.g., during heating and subsequently cooling period through high temperature with near field transducer (NFT), the vertical coupling between the write layer 120 and the storage layer 110 is weakened by the exchange tuning layer 130. As such, the magnetic switching by the write layer 120 in addition to the external magnetization field aids in writing (i.e. switching the magnetization orientation) to the storage layer 110. Thus, a weaker external magnetization field may be used in comparison to an apparatus that does not use the exchange tuning layer 130. Consequently, a lower writing temperature (T_{write}) may be achieved because the exchange tuning layer 130 now aids in writing to the storage layer 110 by decoupling or weakening the magnetization coupling between the storage layer 110 and the write layer 120.

In other words, the exchange tuning layer 130 tunes the magnetic property of the HAMR media 100. The effective anisotropy field of the bi-layer may be defined by the following equation if there is no exchange tuning layer:

$${H}_{k ( eff )} = \frac{{K}_{u 1 ( {T}_{write} )} {V}_{1} + {K}_{u 2 ( {T}_{write} )} {V}_{2}}{{M}_{s 1 ( {T}_{write} )} {V}_{1} + {M}_{s 2 ( {T}_{write} )} {V}_{2}}$$

where K_{u(Twrite)} is anisotropy field at the writing temperature T_{w}, V is the volume of a magnetic grain, M_{s(Twrite)} is room temperature saturation magnetization at writing temperature and subscripts 1 and 2 denote the storage layer and the write layer, respectively. It is appreciated that K_{u2(Twrite)} negligible because the write layer is of cubic structure. As a result, the H_{k(eff)} of the bi-layer is dramatically reduced. Addition of the exchange tuning layer 130 reduces the magnetic coupling between the storage layer and the write layer, therefore, effectively increasing the H_{k(eff)} in the above equation. The exchange tuning layer causes the write layer 120 that is soft to switch first, therefore aiding the external field in writing to the storage layer 110. Since the numerator is reduced and the denominator is increased the effective anisotropy field is reduced, thereby effecting increasing the transducer field. Accordingly, the HAMR media will be switched at a lower temperature, thereby improving performance by reducing superparamagnetic trap effect.

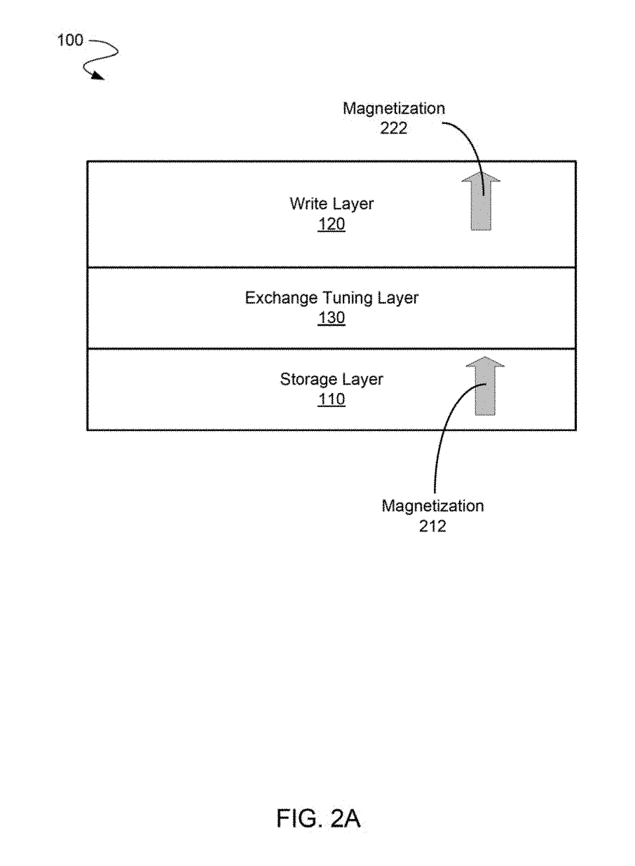

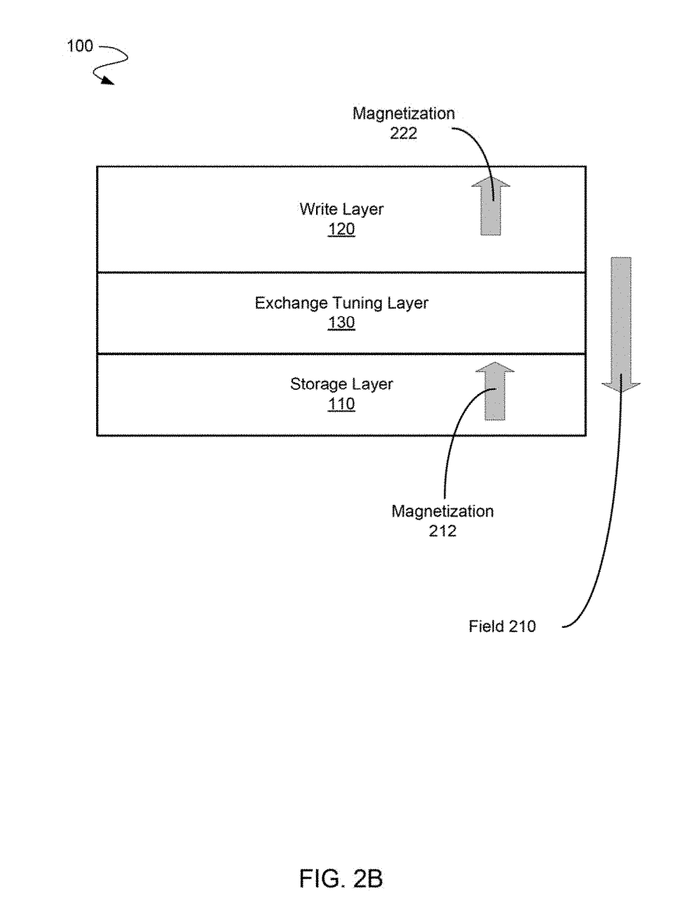

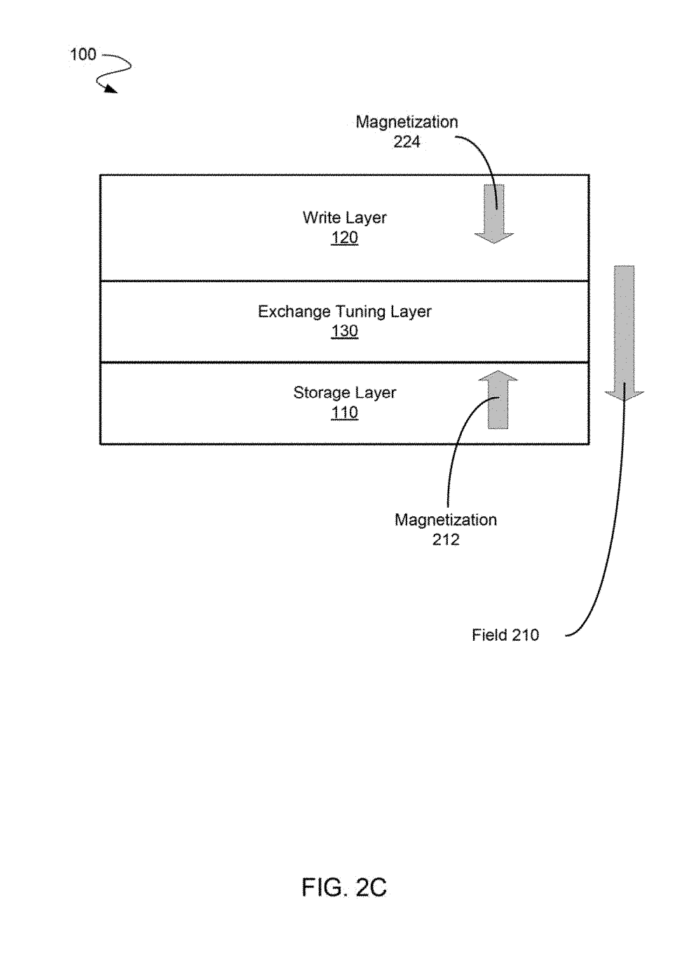

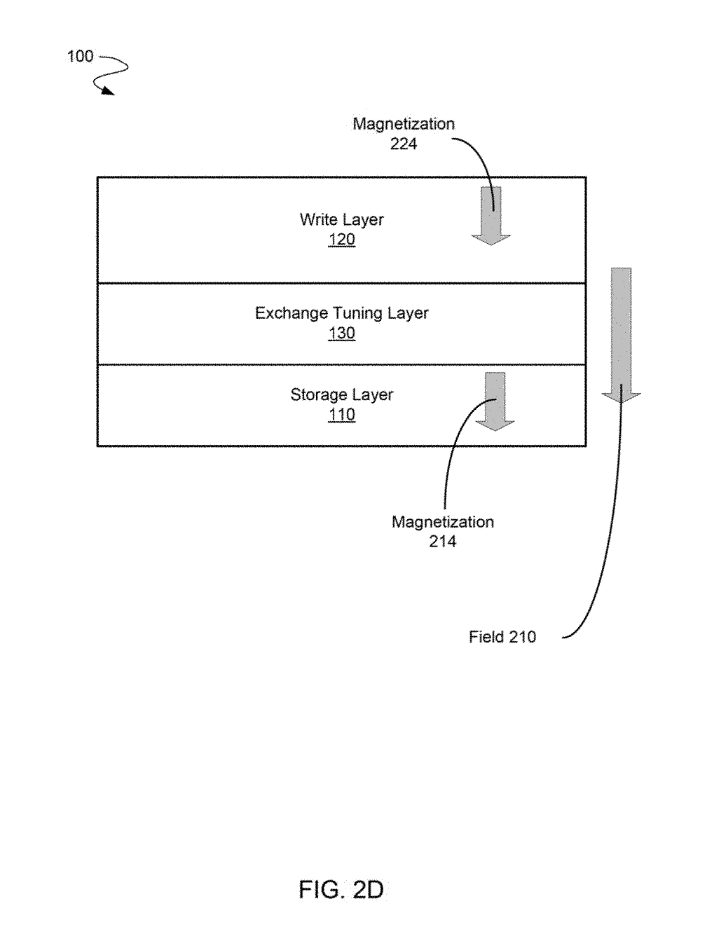

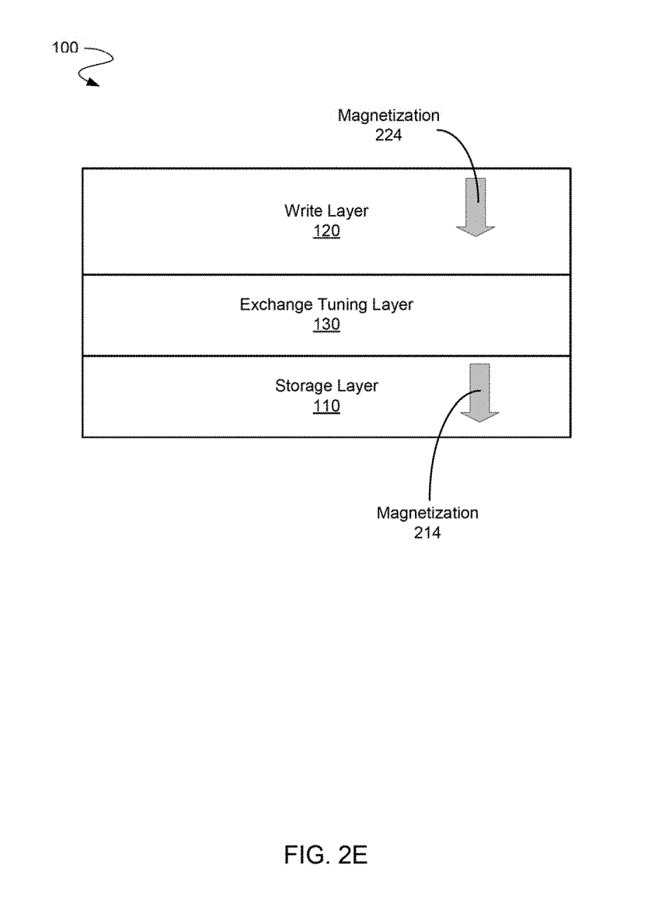

FIGS. 2A-2E show the HAMR media that undergoes a write process according to one aspect of the present embodiments. The HAMR media 100 of FIGS. 2A-2E is similar to that of FIG. 1 described above. FIG. 2A shows magnetization orientation 222 of write layer 120 and the magnetization orientation 212 of the storage layer 110. It is appreciated that while the magnetization orientations 212 and 222 are illustrated as being pointed upward, they may be facing any direction and the direction shown is for illustrative purposes.

Referring now to FIG. 2B, introduction of the external field 210 in order to write to the storage layer 110 is shown. Referring now to FIG. 2C, the exchange tuning layer 130 causes the write layer 120 to switch its magnetic orientation 224 first in presence of the external field 210. It is appreciated that the magnetization orientation of the storage layer 110 has not switched yet. Referring now to FIG. 2D, the change of magnetization orientation 224 of the write layer 120 aids the external field 210 to change the magnetization orientation 214 of the storage layer 110 because the exchange tuning layer 130 weakens the magnetic coupling between the storage layer 110 and the write layer 120. As illustrated, the magnetic orientation of the storage layer 110 now changes which occurs subsequent to the write layer 120 switching its magnetization orientation. Referring now to FIG. 2E, removal of the external field 210 is shown where the magnetization orientations 224 and 214 of the write layer 120 and storage layer 110 respectively are maintained once the temperature falls below the T_{write}.

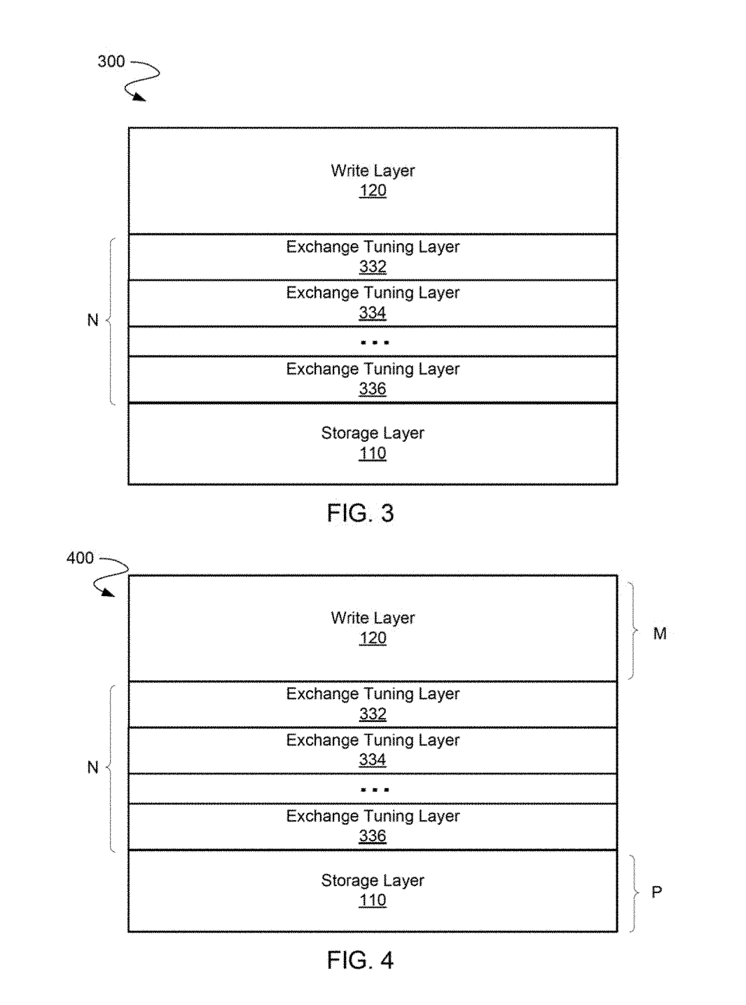

FIG. 3 shows another HAMR media 300 according to one aspect of the present embodiments. HAMR media 300 is substantially similar to that of FIG. 1 and it functions similar to that of FIGS. 2A-2E. However, the HAMR media 300 has multiple, e.g., N, exchange tuning layers 332, 334, . . . , 336. It is appreciated that having more than one layer for the exchange tuning layer may further aid in magnetically decoupling the storage layer 110 from the write layer 120. In some embodiments, the exchange tuning layers 332, 334, . . . , 336 may be the same or alternatively at least two of them may include different material and therefore behave slightly different from one another. Using different material for different exchange tuning layer may further promote epitaxial growth between the storage layer 110 and the write layer 120.

FIG. 4 shows yet another HAMR media according to one aspect of the present embodiments. The HAMR media 400 is similar to that of HAMR media 300. However, the HAMR media 400 may include write layer 120 that has multiple layers, e.g., M layers, and that it includes the storage layer 110 that has multiple layers, e.g., P layers.

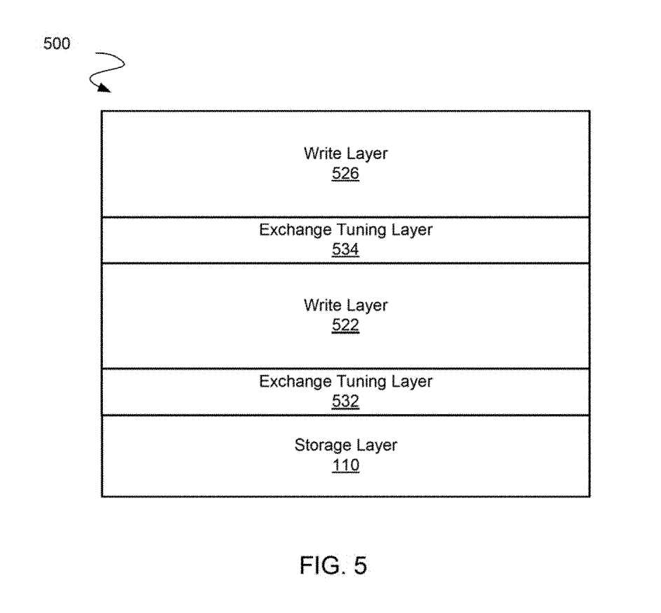

FIG. 5 shows yet another HAMR media 500 variation according to one aspect of the present embodiments. The HAMR media 500 is similar to those described in FIGS. 1-4. However, in this embodiment, two write layers 526 and 522 are interlaced with two exchange tuning layers 534 and 532. In this embodiment, the write layer 526 is disposed over the exchange tuning layer 534, which is disposed over the write layer 522, which is disposed over the exchange tuning layer 532, which is disposed over the storage layer 110. Using multiple write layers and exchange tuning layers interlaced, as illustrated, may further enhance epitaxial growth between the storage layer 110 and ultimately the top write layer 526. Moreover, the multiple write layers and exchange tuning layers interlaced, as illustrated, may further enhance magnetic decoupling between the storage layer 110 and the write layers 522 and 526. As such, the write temperature may further be reduced because now two write layers in addition to the external field aid in writing to the storage layer 110. In other words, the effective anisotropy field is increased without a need to increase the external field of the head.

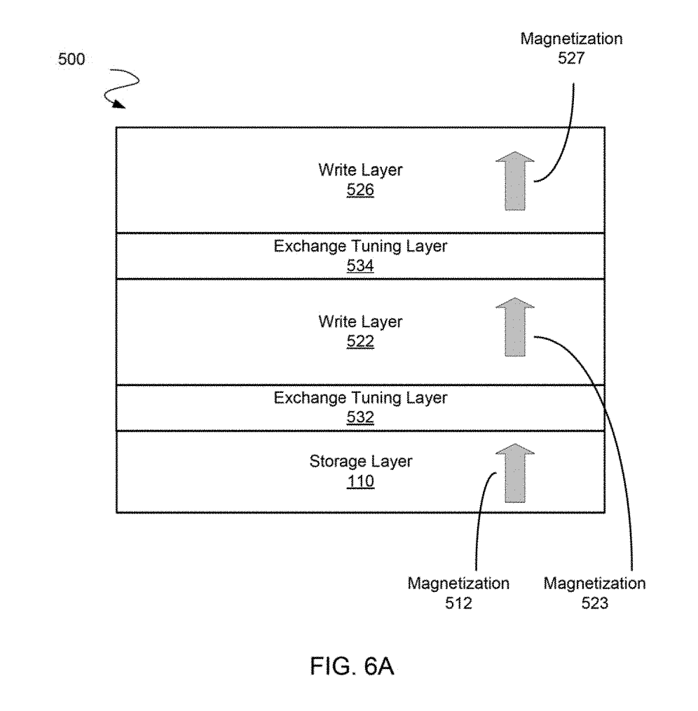

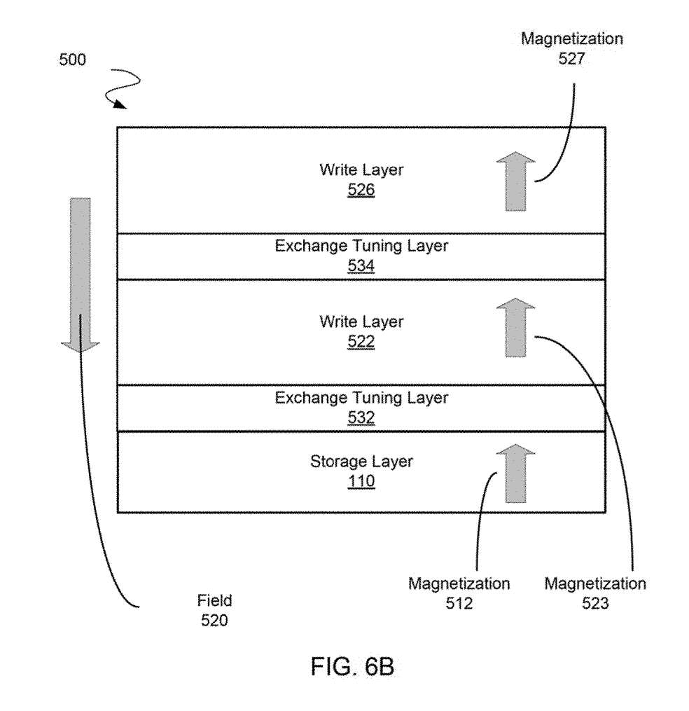

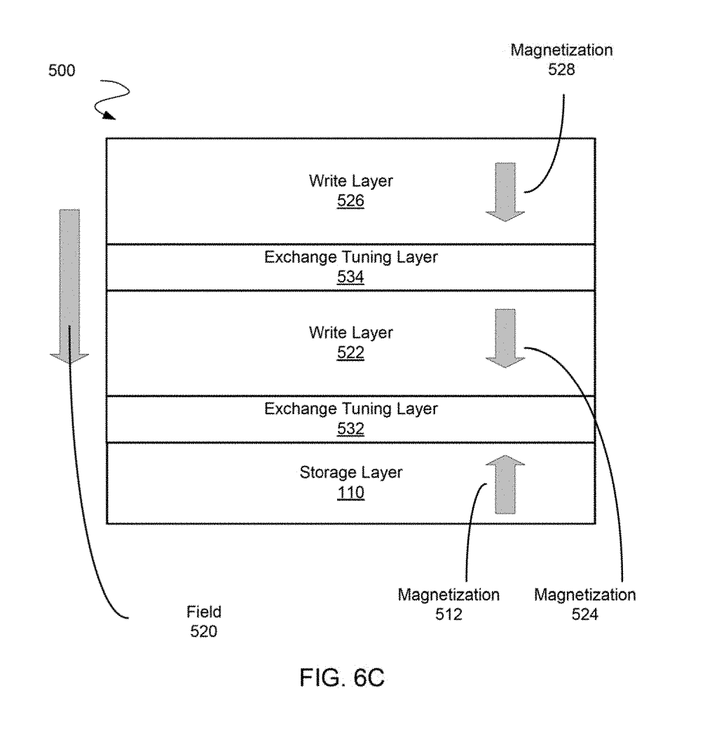

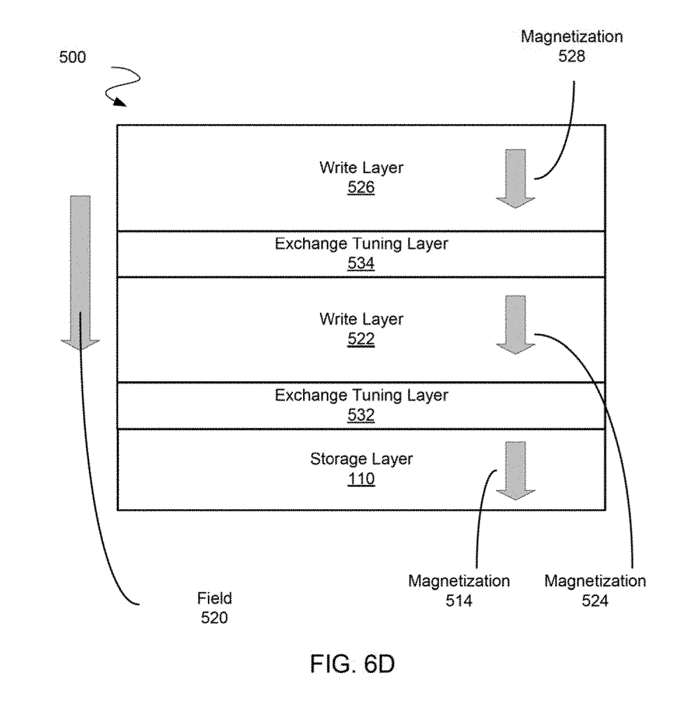

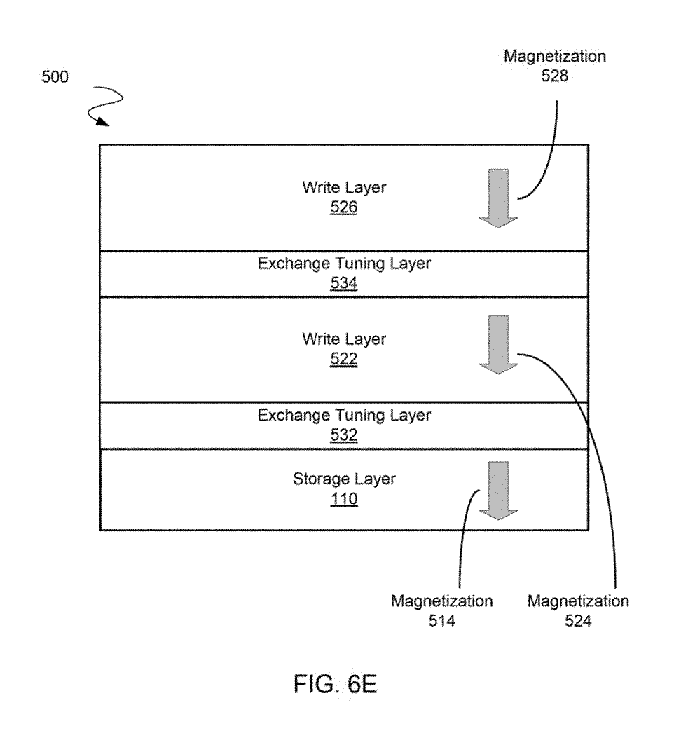

FIGS. 6A-6E show the HAMR media of FIG. 5 that undergoes a write process according to one aspect of the present embodiments. FIG. 6A shows magnetization orientation 527 of write layer 526, magnetization orientation 523 of the write layer 522, and the magnetization orientation 512 of the storage layer 110. It is appreciated that while the magnetization orientations 527, 523, and 512 are illustrated as being pointed upward, they may be facing any direction and the direction shown is for illustrative purposes.

Referring now to FIG. 6B, introduction of the external field 520 in order to write to the storage layer 110 is shown. Referring now to FIG. 6C, the exchange tuning layers 534 and 532 cause the write layers 526 and 522 to switch their magnetic orientations 528 and 524 first in presence of the external field 520. It is appreciated that the magnetization orientation of the storage layer 110 has not switched yet. Referring now to FIG. 6D, the change of magnetization orientation 528 and 524 of the write layers 526 and 522 aid the external field 520 to change the magnetization orientation 514 of the storage layer 110 because the exchange tuning layers 534 and 532 weaken the magnetic coupling between the storage layer 110 and the write layers 526 and 522. As illustrated, the magnetic orientation of the storage layer 110 now changes which occurs subsequent to the write layers 526 and 522 switching their magnetization orientation. Referring now to FIG. 6E, removal of the external field 520 is shown where the magnetization orientations 528, 524, and 514 of the write layers 526 and 522 and storage layer 110 respectively are maintained once the temperature falls below the T_{write}.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. An apparatus comprising:
a storage layer, wherein the storage layer is magnetic;
an exchange tuning layer disposed over the storage layer, wherein the exchange tuning layer is weakly magnetic; and
a write layer disposed over the exchange tuning layer, wherein the write layer is magnetic, and wherein the exchange tuning layer magnetically weakens magnetic coupling between the storage layer and the write layer when heated during a write process of heat assisted magnetic recording (HAMR) media.

2. The apparatus of claim 1, wherein a material of the storage layer is selected from an L1₀ crystalline structure group consisting of FePt, FePtCu, FePtAg, FePtCuAg, FePtMo, FePtCo, FePtNi, CoPt, FeCoPt, and CoPdPt and wherein a material of the write layer is selected from a cubic structure group consisting of FePt, FePtMo, FePtCo, FePtNi, CoPt, FeCoPt, CoNiFe, CoFe, and CoCrPt, CoCrPtRu, and wherein a segregant for each of the storage layer and the write layer is selected from a group consisting of B, C, SiC, BC, TiC, TaC, BN, SiN, TiN, SiO₂, B₂O₃, WO₃, Ta₂O₅, and TiO₂.

3. The apparatus of claim 1, wherein a material of the exchange tuning layer includes PtCo, wherein Co is magnetic with high Curie temperature, and wherein segregant for the exchange tuning layer is selected from a group consisting of C, SiC, BC, TiC, TaC, BN, SiN, TiN, SiO₂, B₂O₃, WO₃, Ta₂O₅, and TiO₂.

4. The apparatus of claim 1, wherein a material of the exchange tuning layer is MgO.

5. The apparatus of claim 1, wherein a Curie temperature of the storage layer is within 30% of a Curie temperature of the write layer.

6. The apparatus of claim 1, wherein the exchange tuning layer is less than or equal to 20 Å.

7. The apparatus of claim 1, wherein the storage layer is a hard magnetic layer and wherein the write layer is a soft magnetic layer, and wherein a magnetization orientation of the write layer is switched in presence of an external magnetization field being applied prior to magnetization orientation of the storage layer switching, and wherein switching of the write layer has an additive effect to the external magnetization field to switch the magnetization orientation of the storage layer subsequent to the switching of the magnetization orientation of the write layer.

8. The apparatus of claim 1, wherein an anisotropy field for writing in the apparatus is reduced in presence of the exchange tuning layer in comparison to an apparatus without the exchange tuning layer.

9. An apparatus comprising:
a granular storage layer, wherein the granular storage layer is magnetic;
a granular exchange tuning layer disposed over the granular storage layer, wherein the granular exchange tuning layer is weakly magnetic; and
a granular write layer disposed over the granular exchange tuning layer, wherein the granular write layer is magnetic, and wherein the granular exchange tuning layer magnetically weakens magnetic coupling between the granular storage layer and the granular write layer when heated during a write process of heat assisted magnetic recording (HAMR) media.

10. The apparatus of claim 9, wherein a material of the storage layer is selected from an L1₀ crystalline structure group consisting of FePt, FePtCu, FePtAg, FePtCuAg, FePtMo, FePtCo, FePtNi, CoPt, FeCoPt, and CoPdPt and wherein a material of the write layer is selected from a cubic structure group consisting of FePt, FePtMo, FePtCo, FePtNi, CoPt, FeCoPt, CoNiFe, CoFe, and CoCrPt, CoCrPtRu, and wherein a segregant for each of the storage layer and the write layer is selected from a group consisting of B, C, SiC, BC, TiC, TaC, BN, SiN, TiN, SiO₂, B₂O₃, WO₃, Ta₂O₅, and TiO₂.

11. The apparatus of claim 9, wherein a material of the granular exchange tuning layer includes PtCo, wherein Co is a magnetic with high Curie temperature, and wherein segregant for the granular exchange tuning layer is selected from a group consisting of C, SiC,

12. The apparatus of claim 9, wherein a material of the granular exchange tuning layer is MgO.

13. The apparatus of claim 9, wherein a Curie temperature of the granular storage layer is within 30% of a Curie temperature of the granular write layer.

14. The apparatus of claim 9, wherein the granular exchange tuning layer is less than or equal to 20 Å.

15. The apparatus of claim 9, wherein the granular storage layer is a hard magnetic layer and wherein the granular write layer is a soft magnetic layer, and wherein a magnetization orientation of the granular write layer is switched in presence of an external magnetization field being applied prior to magnetization orientation of the granular storage layer switching, and wherein switching of the granular write layer has an additive effect to the external magnetization field to switch the magnetization orientation of the granular storage layer subsequent to the switching of the magnetization orientation of the granular write layer.

16. The apparatus of claim 9, wherein an anisotropy field for writing in the apparatus is reduced in presence of the granular exchange tuning layer in comparison to an apparatus without the granular exchange tuning layer.

17. An apparatus comprising:
a storage layer, wherein the storage layer is magnetic;
a first exchange tuning layer disposed over the storage layer, wherein the first exchange tuning layer is weakly magnetic;
a first write layer disposed over the first exchange tuning layer, wherein the first write layer is magnetic, and wherein the first exchange tuning layer magnetically weakens magnetic coupling between the storage layer and the first write layer;
a second exchange tuning layer disposed over the first write layer, wherein the second exchange tuning layer is nonmagnetic; and
a second write layer disposed over the second exchange tuning layer, wherein the second write layer is magnetic, and wherein the second exchange tuning layer magnetically weakens magnetic coupling between the storage layer and the second write layer when heated during a write process of heat assisted magnetic recording (HAMR) media.

18. The apparatus of claim 17, wherein a material of the storage layer is selected from an L1₀ crystalline structure group consisting of FePt, FePtCu, FePtAg, FePtCuAg, FePtMo, FePtCo, FePtNi, CoPt, FeCoPt, and CoPdPt and wherein a material of the write layer is selected from a cubic structure group consisting of FePt, FePtMo, FePtCo, FePtNi, CoPt, FeCoPt, CoNiFe, CoFe, and CoCrPt, CoCrPtRu, and wherein a segregant for each of the storage layer and the write layer is selected from a group consisting of B, C, SiC, BC, TiC, TaC, BN, SiN, TiN, SiO₂, B₂O₃, WO₃, Ta₂O₅, and TiO₂.

19. The apparatus of claim 17, wherein a material of the first and the second exchange tuning layers include PtCo, wherein Co is magnetic with high Curie temperature, and wherein segregant for the first and the second exchange tuning layers is selected from a group consisting of B, C, SiC, BC, TiC, TaC, BN, SiN, TiN, SiO₂, B₂O₃, WO₃, Ta₂O₅, and TiO₂.

20. The apparatus of claim 17, wherein a material of the first and the second exchange tuning layers include MgO.

21. The apparatus of claim 17, wherein a Curie temperature of the storage layer is within 30% of a Curie temperature of the first write layer, and wherein a Curie temperature of the storage layer is within 30% of a Curie temperature of the second write layer.

22. The apparatus of claim 17, wherein a thickness of the first exchange tuning layer is less than or equal to 20 Å, and wherein a thickness of the second exchange tuning layer is less than or equal to 20 Å.

23. The apparatus of claim 17, wherein the storage layer is a hard magnetic layer and wherein the first and the second write layers are a soft magnetic layer, and wherein a magnetization orientation of the first and the second write layers are switched in presence of an external magnetization field being applied prior to magnetization orientation of the storage layer switching, and wherein switching of the first and the second write layers has an additive effect to the external magnetization field to switch the magnetization orientation of the storage layer subsequent to the switching of the magnetization orientation of the first and the second write layers.
